(19) United States
(12) Patent Application Publication
(10) Pub. No.: US 2026/0156469 A1
(43) Pub. Date: Jun. 4, 2026

(54) AUTHORIZATION FOR GROUPS OF UAVS

(71) Applicant: InterDigital Patent Holdings, Inc., Wilmington, DE (US)

(72) Inventors: Taimoor Abbas, Sainte-Julie (CA); Saad Ahmad, Montreal (CA); Samir Ferdi, Kirkland (CA); Behrouz Aghili, Commack, NY (US)

(73) Assignee: InterDigital Patent Holdings, Inc., Wilmington, DE (US)

(21) Appl. No.: 18/707,410

(22) PCT Filed: Nov. 4, 2022
(86) PCT No.: PCT/US2022/048998

§ 371 Date: May 3, 2024

Related U.S. Application Data
(60) Provisional application No. 63/276,317, filed on Nov. 5, 2021.

(51) Int. Cl. H04W 12/08; H04W 4/44

(52) U.S. Cl. CPC H04W 12/08; H04W 4/44

(57) ABSTRACT

Systems, methods, and instrumentalities are described herein for the authorization for groups of unmanned aerial vehicles (UAVs). Examples of enhancing in a UAS service supplier (USS) UAV authorization/authentication (UUAA) procedure to support UAV groups (also called swarms) are provided herein. In examples, a USS via a UAS network function (UAS NF) may provide group-specific provisioning parameters to a policy control function (PCF)/unified data management (UDM). The group-specific provisioning parameters may include at least one of: a group ID; UAV IDs of group members; a leader UAV ID; a USS address; or group subscription-related information. Examples of discovery messages are provided herein. The discovery messages may include at least one of a group ID; a leader UAV ID; and a remote UAV ID. Examples of direct link establishment messages and responses are provided herein. The direct link establishment messages and responses may include a group ID and a remote UAV ID.

### CROSS-REFERENCE TO RELATED APPLICATIONS

This application claims the benefit of Provisional U.S. Patent Application No. 63/276,317, filed Nov. 5, 2021, the disclosure of which is incorporated herein by reference in its entirety.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE).

### SUMMARY

Systems, methods, and instrumentalities are described herein for the authorization for groups of unmanned aerial vehicles (UAVs).

A first wireless/transmit unit (WTRU) may send a first message to a network node. The first message may indicate a request to operate as part of an unmanned aerial vehicle (UAV) group. The WTRU may receive a second message from the network node. The second message may indicate that the request to operate as part of the UAV group has been authorized, the first WTRU has been assigned as a group leader for the UAV group, and UAV group authorization information. The first WTRU may determine from the UAV group authorization information that the group leader is authorized to establish a packet data unit (PDU) session for command and control (C2) group communication.

The first WTRU may send a third message to the network node. The third message may indicate a request for C2 group communication and indicate a leader identification, a group identification, a list of one or more UAVs that are associated with the UAV group, and a request to establish a PDU session (e.g., a first PDU session) for the C2 group communication with the first WTRU. The third message may further indicate a request to prevent a second PDU session (e.g., associated with the UAV group) from being used.

The first WTRU may receive a fourth message from an unmanned aerial vehicle service supplier (USS). The fourth message may indicate C2 group authorization information. The first WTRU may perform a group discovery procedure to determine a UAV identification associated with the second WTRU based on the C2 group authorization information. The first WTRU may send a fifth message to a second WTRU associated with the UAV group. The fifth message may indicate a C2 command. The first WTRU may send a discovery message to the second WTRU. The discovery message may indicate a request for the second WTRU to perform a discovery procedure based on the C2 group authorization information.

In examples, a first network node may send a first message to a USS when it is determined that a first UAV and a second UAV are capable of direct communication. The first message may indicate a request to authorize a group discovery, assign the first UAV as the group leader, and indicate UAV group authorization information. The first network node may determine from the UAV group authorization information that the group leader is authorized to establish PDU session (e.g., a first PDU session) for the C2 group communication. The first network node may receive a request for a second PDU session (e.g., associated with the second UAV). The first network node may send a rejection message based on the assignment of the first UAV as the group leader. The rejection message may indicate that the request for the second PDU session has been rejected.

The first network node may receive a second message from the USS. The second message may indicate an authorization of C2 group communication. The first network node may send a third message to a second network node (e.g., a policy control function (PCF)). The third message may indicate that the first UAV is authorized to perform the group discovery to communicate with the second UAV

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example architecture for supporting a service for a WTRU, such as an unmanned and/or uncrewed aerial system (UAS) service, in a network (e.g., such as a 5GC/EPC).

FIG. 3 illustrates an example architecture that may use a Layer-2 WTRU-to-Network Relay.

FIG. 4 illustrates an example end-to-end control plane for a remote WTRU using Layer-2 WTRU-to-Network Relay.

FIG. 5 illustrates an example architecture using a Layer-e WTRU-to-Network Relay.

FIG. 6 illustrates an example end-to-end control plane for a remote WTRU using Layer-3 WTRU-to-Network Relay.

FIG. 7 illustrates an example of a group of WTRUs, such as a group of unmanned aerial vehicles (UAVs) (which may be referred to as a swarm), where a WTRU member may communicate directly with the core-network as well as via a relay WTRU (e.g., a relay UAV).

FIG. 8 illustrates an example of authorizing a group of WTRU, such as a group of UAVs.

FIG. 9 illustrates an example of a WTRU group authorization procedure, which may be a UAV group authorization procedure.

FIG. 10 illustrates an example of a WTRU group discovery, which may be a UAV group discovery.

FIG. 11 illustrates an example of a WTRU group communication, which may be a UAV group communication.

### DETAILED DESCRIPTION

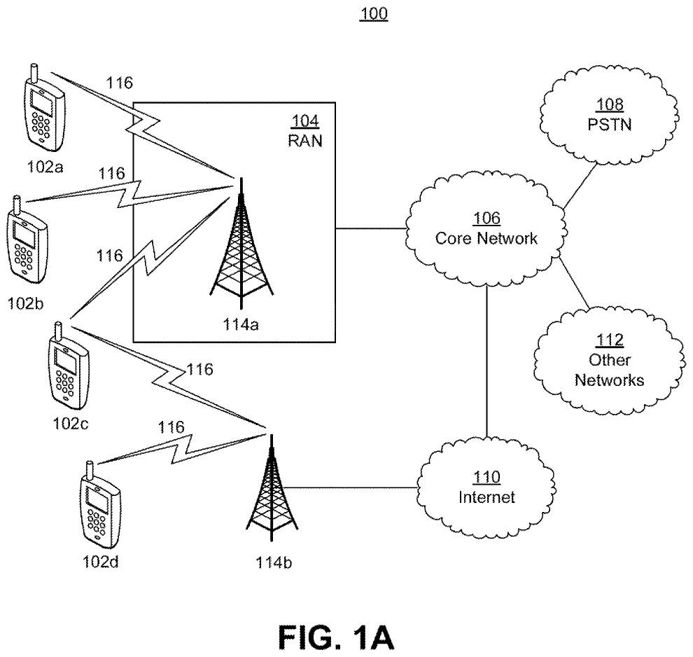

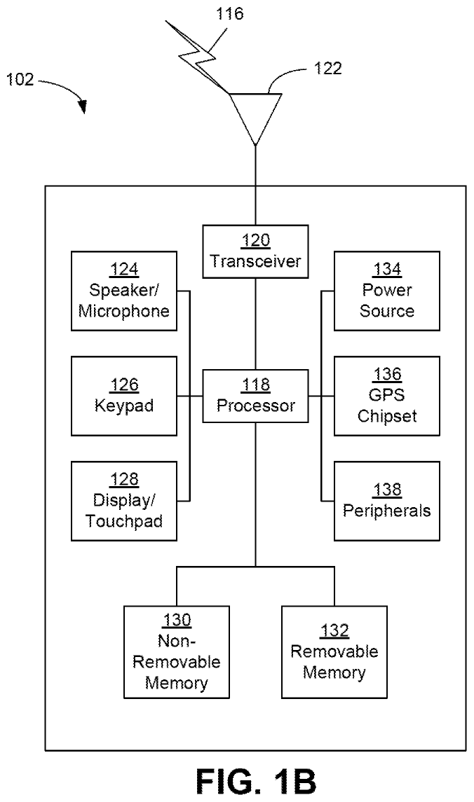

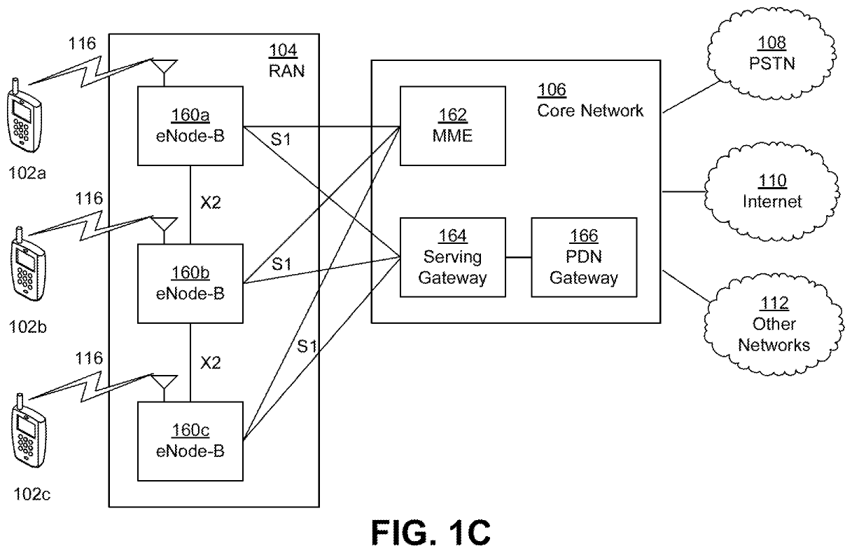

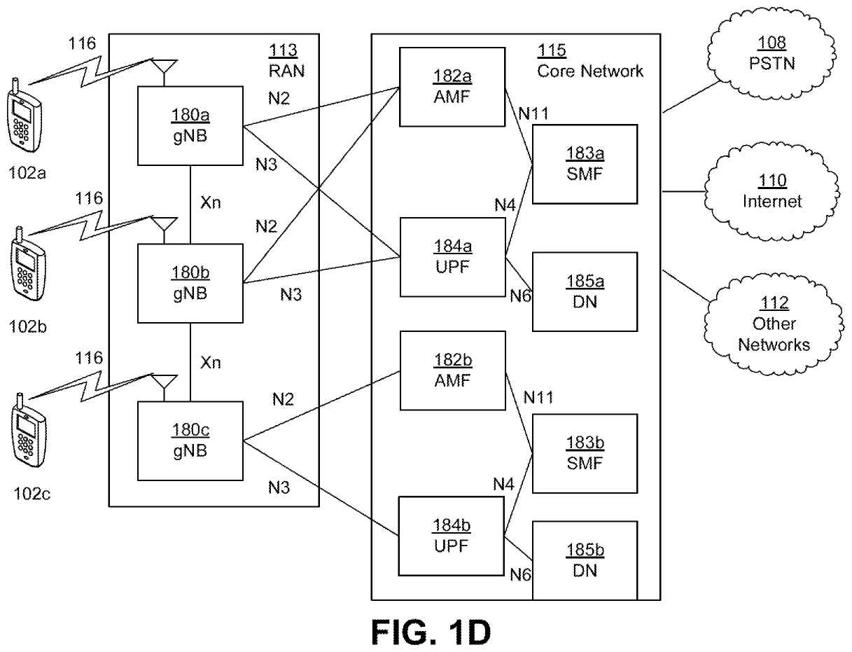

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (loT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WIFI), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VolP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WIMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124 a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, er control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the uplink (UL) (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108.

In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHZ channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTls) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like.

Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Systems, methods, and instrumentalities are described herein for the authorization for groups of unmanned aerial vehicles (UAVs).

A first wireless/transmit unit (WTRU) may send a first message to a network node. The first message may indicate a request to operate as part of an unmanned aerial vehicle (UAV) group. The WTRU may receive a second message from the network node. The second message may indicate that the request to operate as part of the UAV group has been authorized, the first WTRU has been assigned as a group leader for the UAV group, and UAV group authorization information. The first WTRU may determine from the UAV group authorization information that the group leader is authorized to establish a packet data unit (PDU) session for command and control (C2) group communication.

The first WTRU may send a third message to the network node. The third message may indicate a request for C2 group communication and indicate a leader identification, a group identification, a list of one or more UAVs that are associated with the UAV group, and a request to establish a PDU session (e.g., a first PDU session) for the C2 group communication with the first WTRU. The third message may further indicate a request to prevent a second PDU session (e.g., associated with the UAV group) from being used.

The first WTRU may receive a fourth message from an unmanned aerial vehicle service supplier (USS). The fourth message may indicate C2 group authorization information. The first WTRU may perform a group discovery procedure to determine a UAV identification associated with the second WTRU based on the C2 group authorization information. The first WTRU may send a fifth message to a second WTRU associated with the UAV group. The fifth message may indicate a C2 command. The first WTRU may send a discovery message to the second WTRU. The discovery message may indicate a request for the second WTRU to perform a discovery procedure based on the C2 group authorization information.

In examples, a first network node may send a first message to a USS when it is determined that a first UAV and a second UAV are capable of direct communication. The first message may indicate a request to authorize a group discovery, assign the first UAV as the group leader, and indicate UAV group authorization information. The first network node may determine from the UAV group authorization information that the group leader is authorized to establish PDU session (e.g., a first PDU session) for the C2 group communication. The first network node may receive a request for a second PDU session (e.g., associated with the second UAV). The first network node may send a rejection message based on the assignment of the first UAV as the group leader. The rejection message may indicate that the request for the second PDU session has been rejected.

The first network node may receive a second message from the USS. The second message may indicate an authorization of C2 group communication. The first network node may send a third message to a second network node (e.g., a policy control function (PCF). The third message may indicate that the first UAV is authorized to perform the group discovery to communicate with the second UAV.

Examples of enhancing in a USS UAV authorization/authentication (UUAA) procedure to support UAV groups (also called swarms) are provided herein. In examples, a USS via a UAS network function (UAS NF) may provide group-specific provisioning parameters to a PCF/unified data management (UDM). The group-specific provisioning parameters may include at least one of: a group ID; UAV IDs of group members; a leader UAV ID; a USS address; or group subscription-related information. Examples of discovery messages are provided herein. The discovery messages may include at least one of a group ID; a leader UAV ID; and a remote UAV ID. Examples of direct link establishment messages and responses are provided herein. The direct link establishment messages and responses may include a group ID and a remote UAV ID.

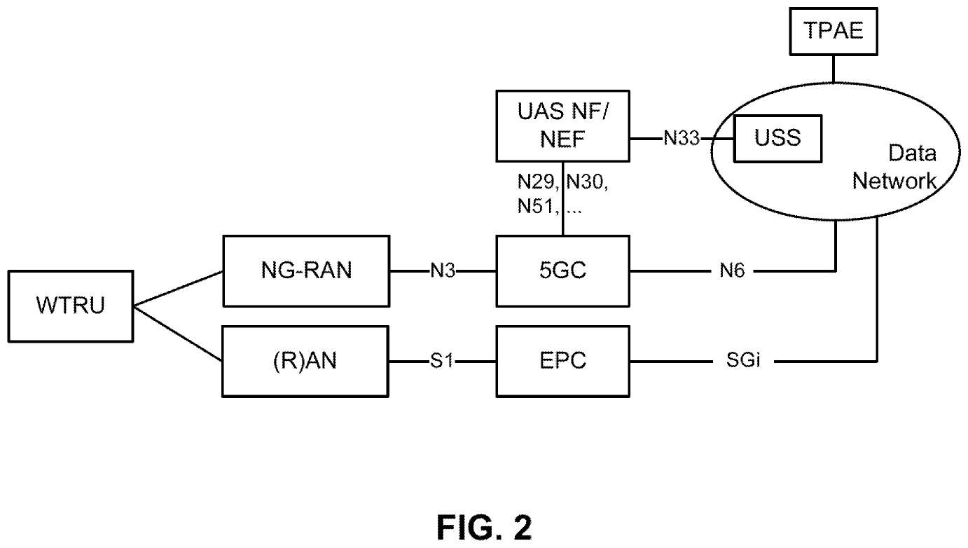

FIG. 2 illustrates an example architecture for supporting a service for a WTRU (e.g., such as an UAS service), in a network (e.g., such as a 5GC/EPC).

UAS connectivity, identification, and/or tracking functionalities may be provided. A network function (e.g., a new network function), such as a UAS NF, may support these tracking functionalities. The UAS NF may take part in the roles of a network exposure function (NEF) for exposure of services to the external USS. The UAS NF may (e.g., may also) support certain UAS-specific procedures such as UUAA and UAS tracking. The UAS NF may (e.g., may also) store some UAS context such as the UUAA result.

Examples of proximity services (ProSe) WTRU-to-Network Relay (e.g., UE-to-Network Relay) are provided herein. The ProSe WTRU-to-Network Relay entity may provide the functionality to support connectivity to the network for remote WTRUs.

If a remote WTRU is out of NR coverage and cannot communicate with the network directly (or is in NR coverage but prefers to use relayed PC5 interface for communication), the remote WTRU may discover and select a ProSe WTRU-to-Network Relay. The remote WTRU may (e.g., may then) establish a PC5 session with the ProSe WTRU-to-Network Relay. The remote WTRU may (e.g., may then) access the network via the ProSe WTRU-to-Network Relay. Examples of a Layer-2 WTRU-to-Network Relay are provided herein.

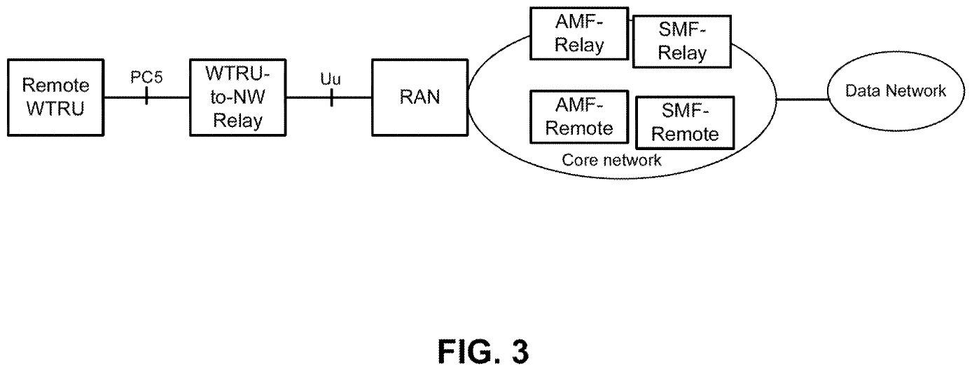

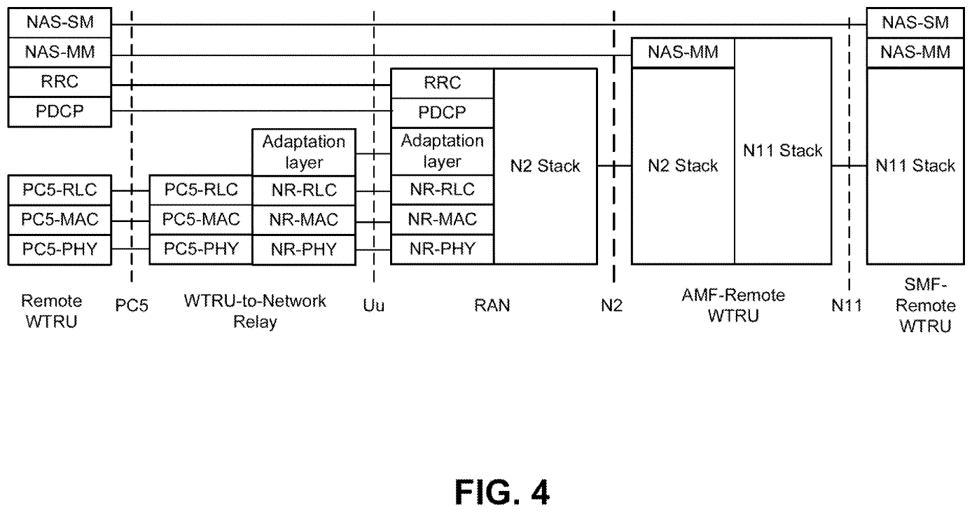

FIG. 3 illustrates an example architecture using a Layer-2 WTRU-to-Network Relay. FIG. 4 illustrates an example end-to-end control plane for a remote WTRU using Layer-2 WTRU-to-Network Relay. The control plane protocol stack is shown in FIG. 4. The Layer-2 WTRU-to-Network Relay may provide the functionality to support connectivity to the network for Layer-2 Remote WTRUs via access stratum (AS) layer forwarding (as shown in FIGS. 3 and 4).

If a session, such as a PC5 session, is established between the Layer-2 Remote WTRU and Layer-2 WTRU-to-Network Relay, the Layer-2 WTRU-to-Network Relay may forward RRC signaling and traffic between the Layer-2 Remote WTRU and the RAN. If receiving signaling from an interface, such as a Uu interface, the RAN may determine whether the signaling received is from the WTRU-to-Network relay itself or the remote WTRU via the WTRU-to-network relay. The RAN may (e.g., may then) perform corresponding procedures with AMF-Relay (AMF, which serves the WTRU-to-Network Relay) or AMF-Remote WTRU (AMF, which serves the remote WTRU). The AMF-Relay and AMF-Remote WTRU may belong to a different core network. To provide AS layer forwarding, the Layer-2 WTRU-to-Network Relay may stay in connected mode if a (e.g., if any) Layer-2 Remote WTRU is in connected mode. Examples of Layer-3 WTRU to Network Relay are provided herein.

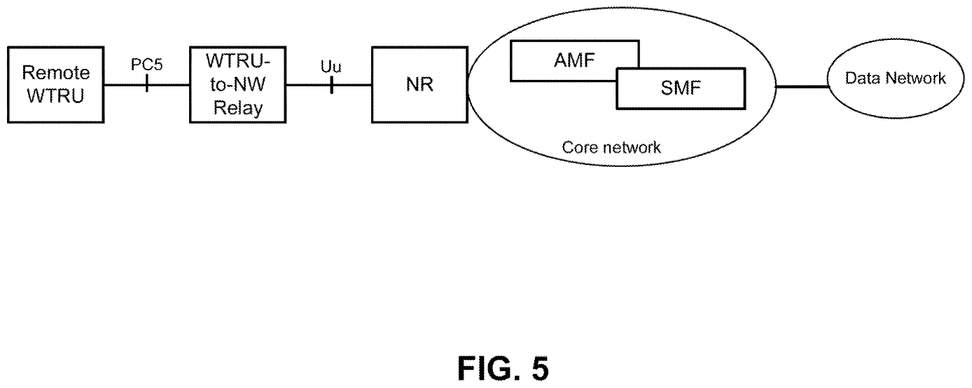

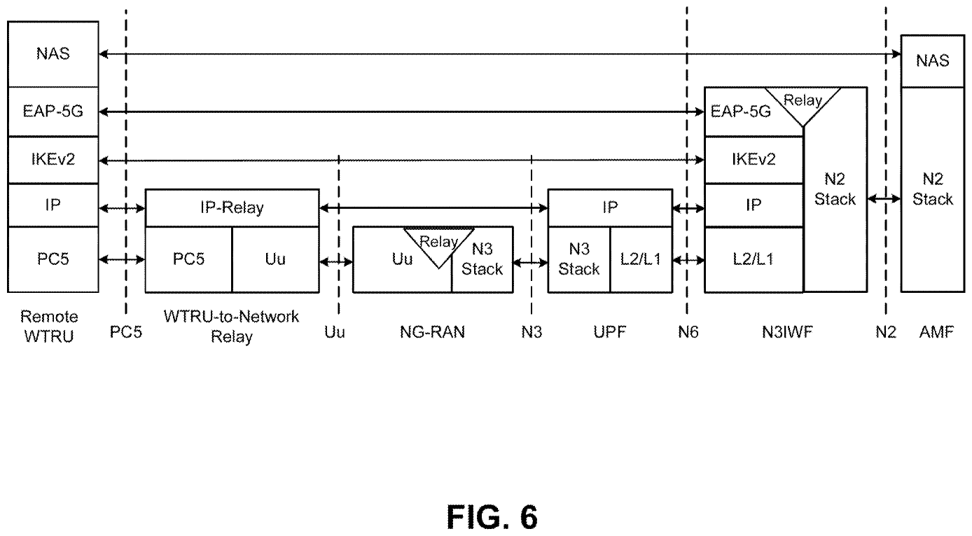

FIG. 5 illustrates an example architecture using a Layer-e WTRU-to-Network Relay. FIG. 6 illustrates an example end-to-end control plane for a remote WTRU using Layer-3 WTRU-to-Network Relay. The Layer-2 WTRU-to-Network Relay may provide the functionality to support connectivity to the network for Layer-2 Remote WTRUs via IP layer forwarding (as shown in FIGS. 5 and 6), If a PC5 session is established between the Layer-3 Remote WTRU and the Layer-3 WTRU-to-Network Relay, the Layer-3 WTRU to Network Relay (e.g., UE-to-Network Relay) may establish a PDU session (e.g., a new PDU session) or may modify an existing PDU session to provide connectivity between a Layer-3 Remote WTRU and a core network. In examples, if an IP type PDU session is established for the Layer-3 Remote WTRU, the Layer-3 WTRU-to-Network Relay may allocate an IP address/prefix to the Layer-3 Remote WTRU. The Layer-3 Remote WTRU may (e.g., may then) use this IP connection to access the internet or access back to Layer-3 Remote WTRU's core network.

Examples of WTRU authentication and authorization, such as UAV authentication and authorization, are provided herein. One or more of the following may apply for UUAA for a UAV: a UUAA-MM may be optional and may be performed at registration, such as at 5GS registration, based on an operator's policy (e.g., if a UUAA-MM is not performed, the UAV may be authenticated at a PDU session establishment in a UUAA-SM); a UUAA-SM may be requested (e.g., required) at PDU session establishments (e.g., each PDU session establishment) (e.g., a packet data network (PDN) connection in a evolved packet system (EPS) for a direct discovery name (DNN) corresponding to UAS services; or a UUAA-SM may be performed at PDU session modifications (e.g., at each PDU session modification) or at EPS bearer modifications (e.g., at each EPS bearer modification) (e.g., in case of C2 authorization or flight plan authorization change) if the WTRU includes a CAA-Level UAV ID and a UUAA Aviation Payload.

There may be scenarios where a number of UAVs are in proximity, whether on-ground or in the air, and may be expected to perform authorization and authentication procedures for UAS communication or C2 communication. UAS communication between a UAV and a USS may be for reporting information to a USS. The reporting information may be periodic status information for a common application and other flight-related parameters. C2 communication may be used for UAV to UAV controller (UAV-C) communication. If UAVs (e.g., each of the UAVs) send this information individually over the air interface in proximity, it may create massive signaling and result in saturation as well as potential interference problems. UAVs may be grouped together as a swarm or a UAV group to utilize group communication, where the group may have a group leader that performs authorization and/or communication on behalf of group members and may send information for the UAVs (e.g., all of the UAVs) to a USS or a UAV-C.

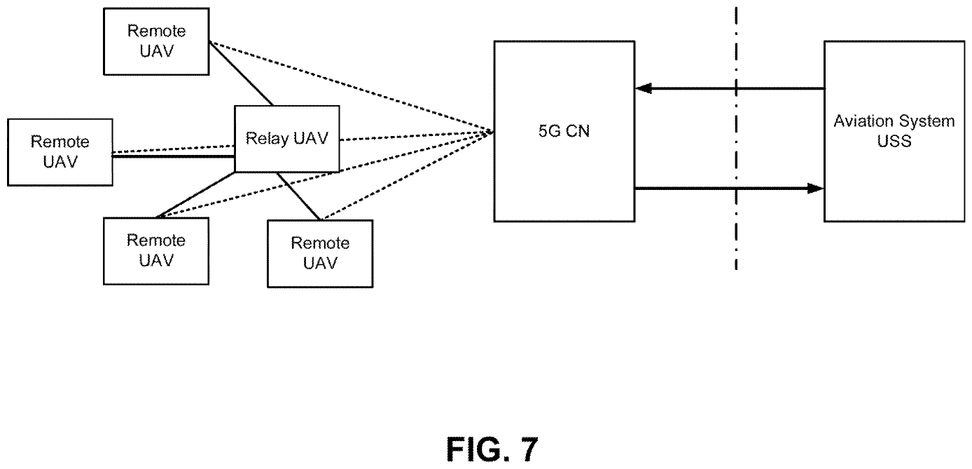

FIG. 7 illustrates an example of a group of WTRUs, such as a group of UAVs (which may be referred to as a “group” herein), where a WTRU member may communicate directly with the core-network as well as via a relay WTRU (e.g., a relay UAV).

A group of UAVs may be authorized to communicate with each other. For example, a group of UAVs may be authorized to use UAS communication and/or C2 communication. The UAVs in a group may discover each other. The UAVs in a group may establish direct communication with each other.

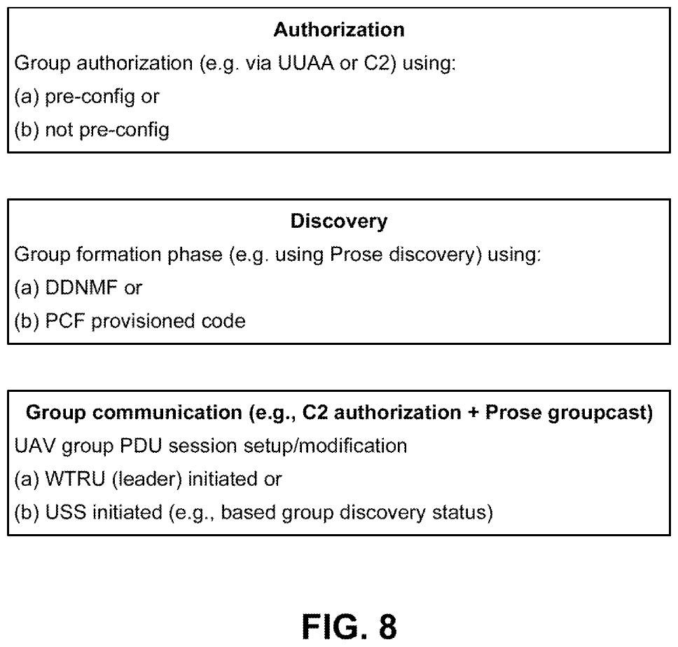

FIG. 8 illustrates an example of authorizing a group of WTRUs, such as a group of UAVs.

The WTRU may indicate its 5G ProSe capability, relay capability, and/or its pre-configured group information in the registration request. The WTRU may indicate the CAA level UAV ID and other UAV-related parameters (e.g., USS address). The AMF may forward the ProSe/relay capability and group info to the USS via a UAS NF.

The WTRU may receive, in the UUAA-MM/SM, a response from the USS, which may include group-related parameters (e.g., a group ID, max size of group, a group leader ID), the other UAV group-related parameters, and an explicit indication telling the WTRU that the WTRU is authorized for UAV group communication. The WTRU may (e.g., may also) receive information about the type of PC5 link authorized for a UAV communication (e.g., broadcast, multicast, and/or unicast).

The WTRU may perform the discovery procedure with a direct discovery name management function (DDNMF), indicating that the WTRU is authorized for UAV group communication. The WTRU may include a group ID (e.g., an application layer group ID set to a USS-assigned group ID). The relay or announcing WTRU may allocate the RSC or discovery code based on the received group ID and UAV authorized indication. The other WTRUs/monitoring WTRUs may allocate the discovery filters based on the received group ID and UAV authorized indication.

WTRUs may perform discovery based on the received UAV discovery codes or discovery filters. WTRUs may perform group communication (e.g., a group leader may enable C2 communication for group members (e.g., all group members) and a PDU session request/modification for the group members (e.g., all the group members).

In examples, the authorization for UAVs, whether a UUAA or a C2 authorization, may be performed for UAVs (e.g., each UAV) individually, where UAVs may communicate (e.g., may directly communicate) using a Uu link with the USS via core network for authentication and authorization. If the UAVs nearby are controlled by the same operator and if the UAVs can connect to PC5 and 5G ProSe, with some of them acting as relays for other remote UAVs, then the authorization procedure may be enhanced for group authorization.

Examples of UAV group authorization are provided herein. There may be one or more of the following scenarios for the group authorization: a UAV may be pre-configured with UAV group info; a UAV may receive authorized group info from a USS as part of a UUAA (e.g., when being authorized for a UAS as a group); or a UAV may receive authorized group information from a USS as part of a C2 (e.g., when being authorized for a UAS as a group).

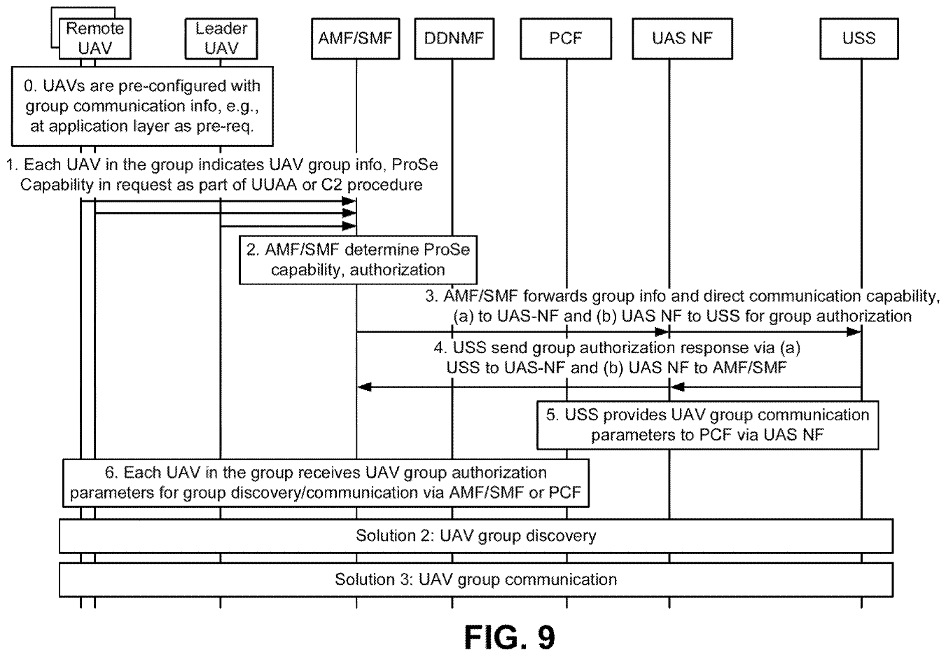

FIG. 9 illustrates an example of a UAV group authorization procedure. It may be assumed that the UAVs are pre-configured (e.g., at the application layer) with group communication information (e.g., as a pre-requisite), and the UAV may send this information as part of a container in a subsequent UUAA or C2 procedure.

At 0 (as shown in FIG. 9), UAVs (e.g., a first WTRU/leader UAV and/or remote UAV(s) may be preconfigured with the group communication information (e.g., an application layer group ID, group size, group leader criteria, etc.) at the application layer as a pre-requisite. The WTRU may receive this configuration info from a USS or a 3rd party app server.

At 1, a UAV (e.g., each UAV, including the first WTRU/leader UAV and remote UAV(s), which may be pre-configured with group information and possess ProSe capability, may indicate (e.g., via a first message) UAV group information and the ProSe capability to a network node (e.g., an AMF/SMF) to operate as part of UAV group in the initial request container as part of a UUAA or C2 procedure.

At 2, the network node (e.g., the AMF/SMF) may determine ProSe capability and/or authorization based on the requirements (e.g., if it is for UUAA or C2 authorization).

At 3, the network node (e.g., the AMF/SMF) may forward group information (e.g., UAV IDs, application layer group ID, group size, etc.) and ProSe capabilities: in 3a from the network node (e.g., the AMF/SMF) to another network node (e.g., a UAS NF); and in 3b from the network node (e.g., via a message from the UAS NF) to a USS if (e.g., when) it is determined the first UAV and the second UAV are capable of direct communication. The first message from the UAS NF to the USS may indicate a request to group discovery, assign the first WTRU/leader UAV as the group leader, and indicate UAV group authorization information (e.g., including a PDU session for C2 group communication). Multiple messages may be exchanged between the USS and the UAVs based on the authentication and authorization procedure.

At 4, the USS may send a group authorization response (e.g., via a message) to the network node (e.g., the AMF/SMF) via (a) the USS to a network node (e.g., the UAS NF) and (b) the network node (e.g., the UAS NF) to another network node (e.g., an AMF/SMF), which may include authorized UAV group information (e.g., a group ID, a max group size, a group leader ID, etc.) as well as security information for group discovery, C2 group communication, and an authorization of C2 group communication. The USS may or may not assign the group leader, which may impact the discovery and communication phases.

At 5, (e.g., which may be an alternative to 4), the USS may provide UAV group information (e.g., authorizing the first WTRU/leader UAV to perform group discovery to communicate with the second WTRU/UAV-C) to a network node (e.g., a PCF) via a message received from another network node (e.g., the UAS NF).

At 6, UAVs (e.g., the first WTRU/leader UAV and the remote UAV(s)) may receive (e.g., via a second message from a network node (e.g., an AMF/SMF or a UAS NF), an indication that the request to operate as a part of the UAV group has been authorized. The indication may include group authorization parameters (e.g., UAV group authorization information) for UAV group discovery to discover other group members, that a UAV (e.g., the first WTRU/leader UAV) has been assigned as the group leader, and for UAV group communication (e.g., mapping prose L2 ID, a UAV group ID, a group leader ID, security info, etc.). The group leader (e.g., the first WTRU/leader UAV) for one or more WTRUs may receive an indication (e.g., via the group authorization information) that they are authorized to establish a PDU session (e.g., a first PDU session) for C2 communication on behalf of the UAV group via a network node (e.g., a PCF) in universal control unit (UCU) updates (as shown in 5); and/or another network node (e.g., the AMF/SMF) in non-access stratum (NAS) response containers (as shown in 4).

In examples, the UAVs (e.g., the first WTRU/leader UAV and/or the remote UAV(s) may be assumed to be configured with group information and group authorization information as part of a container in a UUAA or a C2 authorization procedure, as it may not have any pre-configured group information. The UAV may be assigned dynamically to a group at a UUAA or a C2 (e.g., only at a UUAA or a C2) based on USS logic. The dynamic UUAA/C2 authorization based group authorization scenario, where 1 to 4 in FIG. 9 are updated, may include the following:
At 1, the UAV (e.g., the first WTRU/leader UAV) may request a UUAA or a C2 authorization (e.g., optionally with ProSe capability in a container).

At 2, a network node (e.g., an AMF/SMF) may determine ProSe capability and/or authorization based on the requirements (e.g., if it is for a UUAA or a C2 authorization).

At 3, the network node (e.g., the AMF/SMF) may forward ProSe capabilities as an additional parameter: in 3a from the network node (e.g., the AMF/SMF) to another network node (e.g., a UAS NF); and in 3b from the network node (e.g., via a first message from the UAS NF) to a USS. Multiple messages may be exchanged between the USS and the UAVs based on the authentication and authorization procedure being used.

At 4, the USS may be based on implemented logic and may determine whether UAV group communication is needed for certain UAVs or not. If yes, then the USS may authorize those UAVs for group discovery and group communication.

At 5, the USS may send an authorization response to a network node (e.g., an AMF/SMF) via: (a) a USS to a network node (e.g., a UAS NF); and (b) the network node (e.g., the UAS NF) to another network node (e.g., the AMF/SMF), which may include authorized UAV group information (e.g., a group ID, max group size, a group leader ID, etc.) as well as security information for group discovery and group communication. The group leader may or may not be assigned by the USS, which may impact the discovery and communication phases.

Examples of UAV group discovery may be provided. In examples, the UAV group discovery procedure may be specified where the group members'discovery may be performed using the ProSe discovery in different ways (e.g., two ways: static via the DDNMF, or dynamic via a PCF provisioned code).

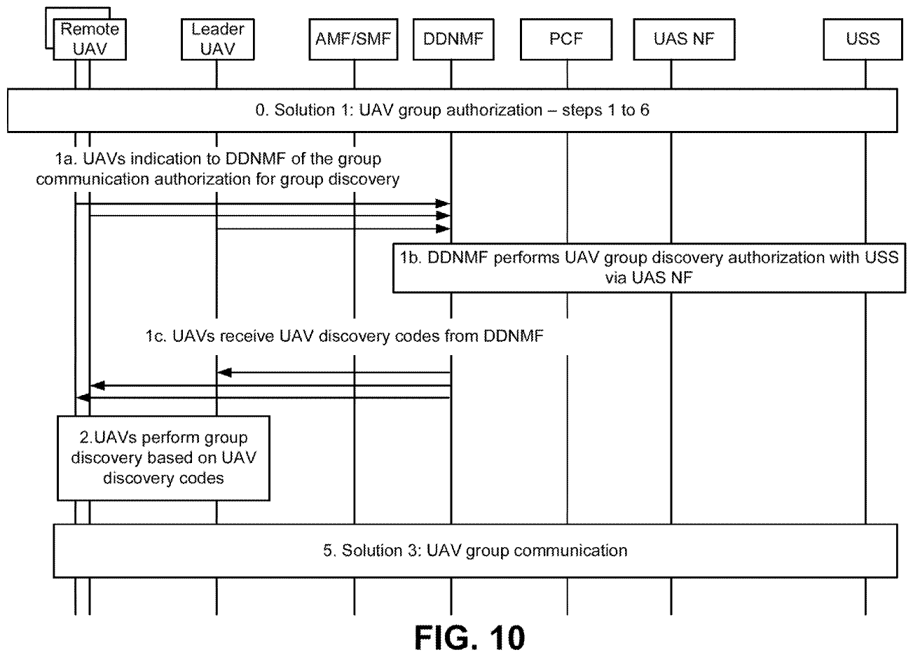

FIG. 10 illustrates an example of UAV group discovery. At 0, the UAV group authorization 1 to 6 in FIG. 9 may be performed. At 1, if the group information at 4 in FIG. 9 is received at the UAV from USS via a NAS message from a network node (e.g., an AMF/SMF), then the UAVs (e.g., the first WTRU/leader UAV and/or remote UAV(s) may receive UAV group discovery codes via a network node (e.g., a DDNMF). The UAVs (e.g., the first WTRU/leader UAV and/or remote UAV(s)) may include other group-related parameters as described at 6 in FIG. 9 in the message to the network node (e.g., the DDNMF). At 1a, the UAVs (e.g., the first WTRU/leader UAV and/or the remote WTRU(s)) may indicate to a network node (e.g., the DDNMF) for group discovery authorization. The UAVs may provide group communication authorization information as received from a USS. If group discovery has been performed, the group leader (e.g., the first WTRU/leader UAV) may notify the USS via the network node (e.g., the DDNMF) of a change in the number of group members (e.g., the remote UAV(s). Member WTRU(s) (e.g., the remote UAV(s)) may (e.g., may also) notify a USS if they disconnect with a UAV group leader (e.g., the first WTRU/leader UAV). At 1b, if the network node (e.g., the DDNMF) receives a UAV group discovery authorization request, the network node (e.g., the DDNMF) may request authorization from a USS via another network node (e.g., a UAS NF) by including a UAV group ID, UAV member IDs, and may include new/old member IDs in case any member leaves or joins an existing group. The USS based on USS logic may provide a UAV group discovery authorization and may include UAV discovery codes/RSC, a group ID, and an optional leader UAV ID to the network node (e.g., the DDNMF). At (c), the UAVs (e.g., the first WTRU/leader UAV and/or the remote UAV) may receive UAV discovery codes/RSC, a group ID, and a leader UAV ID from the network node (e.g., the DDNMF).

At 2, if the group information of 5 in FIG. 9 is received at the UAV (e.g., the first WTRU/leader UAV) from the USS via a PCF in the UCU update, then UAVs (e.g., the first WTRU/leader UAV and/or the remote UAV) may perform group discovery based on the UAV group discovery codes received from a PCF. If assigned already by the USS, the group leader (e.g., the first WTRU/leader UAV) may perform the group members'discovery based on the group information. In examples, the group leader (e.g., the first WTRU/leader UAV) may perform a group discovery procedure to determine a UAV identification associated with a UAV-C (e.g., a second WTRU) based on C2 group authorization information. In the announcement/solicitation message (e.g., a discovery message), the group leader (e.g., the first WTRU/leader UAV) may include a group C2 service indication (e.g., the first WTRU/leader UAV may communicate to the second WTRU/UAV-C on behalf of the group, indicating a request for the second WTRU/UAV-C to perform a discovery procedure based on C2 group authorization information). At 3, UAV group communication may be provided.

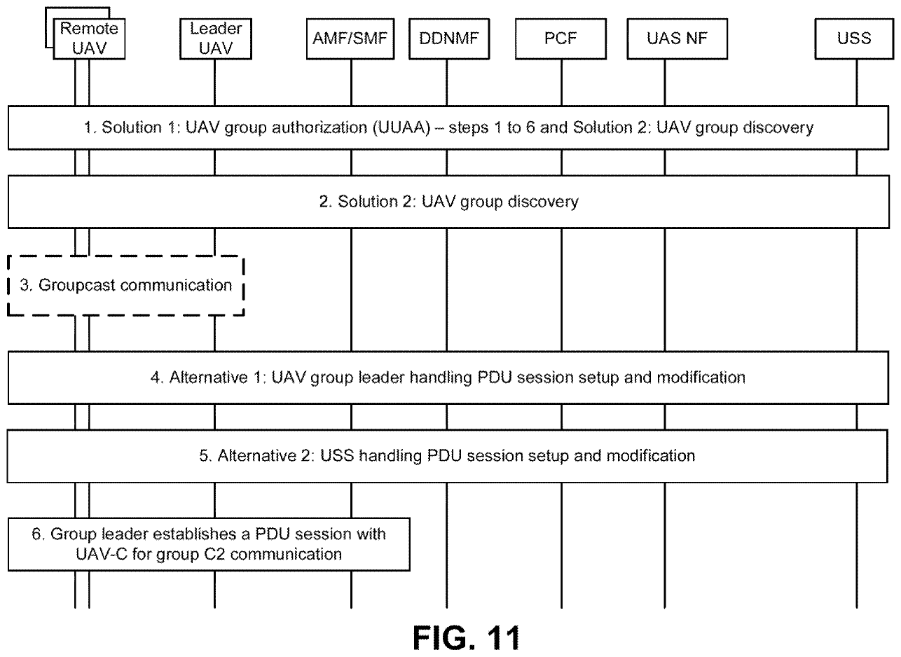

FIG. 11 illustrates an example of UAV group communication. In FIG. 11, it may be assumed that the UAVs in a group have already performed UUAA and UAV group discovery as shown in FIGS. 9 and 10. For UAV group communication (e.g., UAV group PDU session setup and modification), there may one or more of the following alternatives: the UAV group leader (e.g., the first WTRU/leader UAV) may initiate a PDU session setup and modification; or the USS may initiate a PDU session setup and modification.

At 1, if the UUAA-MM is done in the example group authorization in FIG. 9, the group leader (e.g., the first WTRU/leader UAV) may set up C2 authorization with a UAV-C (e.g., a second WTRU). If the UUAA-SM is done in the example group authorization in FIG. 9, the PDU session (e.g., the first PDU session) may be available for C2.

At 2, for the UAV group discovery in FIG. 10, the group leader (e.g., the first WTRU/leader UAV) may be provisioned in 6 of FIG. 9, or it may be dynamically chosen during the discovery in FIG. 10. The sequence of a C2 authorization with a leader perspective may imply that the C2 authorization may be done beforehand for UAVs (e.g., each UAV) and that group authorization may be performed as part of the C2 authorization procedure. The discovery may be symmetrical, as the UAVs (e.g., all of the UAVs) may have received the same information, and the USS may assign a leader.

At 3, group cast communication may be established between the group members (e.g., the remote UAVs) and first WTRU/leader UAV.

At 4, the UAV group leader (e.g., the first WTRU/leader UAV) may handle PDU session setup and modification. The UAV leader, based on group discovery, group definition information, and possibly the received indication in 6 of FIG. 9 that it is authorized to establish a PDU session (e.g., a first PDU session) for the group of UAVs, may perform the procedure in terms of C2 handling. The procedure may be performed as described below.

The group leader (e.g., the first WTRU/leader UAV) may perform the following. The group leader (e.g., the first WTRU/leader UAV) may request C2 group authorization information as a leader, which may be different from the individual UAV C2 authorization. The group leader (e.g., the first WTRU/leader UAV) may initiate a UAV group PDU session (e.g., first PDU session) establishment request (e.g., via a third message) for C2 group communication (e.g., from the UAV group to a second WTRU/UAV-C, once the group is formed, and may include a group ID, member UAV IDs, a leader ID, group authorization information, etc.). The group leader (e.g., the first WTRU/leader UAV) may initiate PDU session modification (e.g., a second PDU session) for C2 group communication, where it may request (e.g., via the third message) to block PDU sessions (e.g., the second PDU session) for group members and fully enable a PDU session (e.g., the first PDU session) for the leader, and may include a group ID, member UAV IDs, a leader ID, etc. The PDU session modification (e.g., the second PDU session) may be associated with a second WTRU/UAV-C and may be received in a network node (e.g., the UAS NF). The network node (e.g., the UAS NF) may send a rejection message (e.g., indicating the rejection of the second PDU session) based on the assignment of the first WTRU/leader UAV as the group leader.

At 5, the USS may handle a PDU session setup and modification. There may be scenarios where USS initiates the PDU session setup or modification as described herein. If anyone other than the group leader (e.g., first WTRU/leader UAV) takes charge or there is any other change in the group, then the USS may initiate a PDU session modification command. If the group size is dynamic or unexpected, then the USS may decide for the group leader if it may establish a PDU session for C2 group communication or not. The USS may have to control or check the group members (e.g., may not provide a second WTRU/UAV-C IP address until the group members (e.g., all the group members or the required group members) are there).

The group leader (e.g., the first WTRU/leader UAV) may identify and report a change in the number of group members to the USS. The USS may initiate a policy control and a PDU session modification request.

The first WTRU/leader UAV may disappear. In that case, (e.g., something goes wrong with the first WTRU/leader UAV), the USS may assign a new group leader and initiate a PDU session modification for C2 group communication. The USS may indicate C2 group authorization information (e.g., via a fourth message).

At 6, the group leader (e.g., the first WTRU/leader UAV) may complete the establishment of the PDU session or may enable the PDU session through modification following the procedures described herein. The group leader (e.g., the WTRU/leader UAV) may establish a PDU session (e.g., via a fifth message) with the second WTRU/UAV-C (e.g., associated with the UAV group) for C2 group communication and may re-transmit (e.g., via the fifth message) to the second WTRU/UAV-C (e.g., associated with the UAV group) UAV group C2 commands, report location, etc. on behalf of the group (e.g., the group leader may act as a C2 proxy, remote ID (RID) client for the group).

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor, Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-18. (canceled)

19. A first wireless transmit/receive unit (WTRU), comprising:
a processor configured to:
send a first message to a first network node, wherein the first message indicates a request to operate as part of an unmanned aerial vehicle (UAV) group;
receive a second message from the first network node, wherein the second message indicates that the request to operate as part of the UAV group has been authorized, indicates that the first WTRU has been assigned as a group leader for the UAV group, and indicates UAV group authorization information that comprises a leader identification;
send a third message to a second network node, wherein the third message indicates a request for command and control (C2) group communication and indicates the leader identification;
receive a fourth message from the second network node, wherein the fourth message indicates C2 group authorization information; and
send a fifth message to a second WTRU based on the C2 group authorization information, wherein the fifth message indicates a C2 command, and wherein the second WTRU is associated with the UAV group.

20. The first WTRU of claim 19, wherein the processor is further configured to:
determine from the UAV group authorization information that the group leader is authorized to establish a packet data unit (PDU) session for the C2 group communication.

21. The first WTRU of claim 20, wherein the third message further indicates a request to establish the PDU session for the C2 group communication with the first WTRU.

22. The first WTRU of claim 20, wherein:
the PDU session is a first PDU session;
the third message further indicates a request to prevent a second PDU session from being used; and
the second PDU session is associated with the UAV group.

23. The first WTRU of claim 19, wherein the processor is further configured to:
send a discovery message to the second WTRU, wherein the discovery message indicates a request for the second WTRU to perform a discovery procedure based on the C2 group authorization information.

24. The first WTRU of claim 19, wherein the processor is further configured to:
perform a group discovery procedure to determine a UAV identification associated with the second WTRU based on the C2 group authorization information.

25. The first WTRU of claim 19, wherein the third message further indicates a group identification and a list of one or more UAVs associated with the UAV group.

26. The first WTRU of claim 19, wherein the C2 group authorization information comprises group-related parameters, and wherein the group-related parameters comprise one or more of: a group ID, UAV IDs of group members, the leader identification, a unmanned aerial system service supplier (USS) address, or group subscription-related information.

27. A method implemented in a first wireless transmit/receive unit (WTRU), comprising:
sending a first message to a first network node, wherein the first message indicates a request to operate as part of an unmanned aerial vehicle (UAV) group;
receiving a second message from the first network node, wherein the second message indicates that the request to operate as part of the UAV group has been authorized, indicates that the first WTRU has been assigned as a group leader for the UAV group, and indicates UAV group authorization information that comprises a leader identification;
sending a third message to a second network node, wherein the third message indicates a request for command and control (C2) group communication and indicates the leader identification;
receiving a fourth message from the second network node, wherein the fourth message indicates C2 group authorization information; and
sending a fifth message to a second WTRU based on the C2 group authorization information, wherein the fifth message indicates a C2 command, and wherein the second WTRU is associated with the UAV group.

28. The method of claim 27, further comprising:
determining from the UAV group authorization information that the group leader is authorized to establish a packet data unit (PDU) session for the C2 group communication.

29. The method of claim 28, wherein the third message further indicates a request to establish the PDU session for the C2 group communication with the first WTRU.

30. The method of claim 28, wherein:
the PDU session is a first PDU session;
the third message further indicates a request to prevent a second PDU session from being used; and
the second PDU session is associated with the UAV group.

31. The method of claim 27, further comprising:
sending a discovery message to the second WTRU, wherein the discovery message indicates a request for the second WTRU to perform a discovery procedure based on the C2 group authorization information.

32. The method of claim 27, further comprising:
performing a group discovery procedure to determine a UAV identification associated with the second WTRU based on the C2 group authorization information.

33. The method of claim 27, wherein the third message further indicates a group identification and a list of one or more UAVs associated with the UAV group.

34. The method of claim 27, wherein the C2 group authorization information comprises group-related parameters, and wherein the group-related parameters comprise one or more of: a group ID, UAV IDs of group members, the leader identification, a unmanned aerial system service supplier (USS) address, or group subscription-related information.

35. A first network node, comprising:
a processor configured to:
send a first message to a second network node when it is determined that a first UAV and a second UAV are capable of direct communication, wherein the first message indicates a request to authorize a group discovery, assigns the first UAV as a group leader, and indicates UAV group authorization information;
receive a second message from the second network node, wherein the second message indicates an authorization of command and control (C2) group communication; and
send a third message to a third network node, wherein the third message indicates that the first UAV is authorized to perform the group discovery to communicate with the second UAV.

36. The first network node of claim 35, wherein the processor is further configured to:
determine from the UAV group authorization information that the group leader is authorized to establish a packet data unit (PDU) session for the C2 group communication.

37. The first network node of claim 36, wherein the PDU session is a first PDU session, and wherein the processor is further configured to:
receive a request for a second PDU session, wherein the second PDU session is associated with the second UAV; and
send a rejection message based on the assignment of the first UAV as the group leader, wherein the rejection message indicates that the request for the second PDU session has been rejected.

38. The first network node of claim 35, wherein the second network node is a unmanned aerial system service supplier (USS) and the third network node is a policy control function (PCF).
